(19) United States
(12) Patent Application Publication
(10) Pub. No.: US 2005/0046733 A1
(43) Pub. Date: Mar. 3, 2005

(54) Scanner motor assembly

(75) Inventor: Doo-Jin Bang, Yongin-city (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-Si (KR)

(21) Appl. No.: 10/845,088

(22) Filed: May 14, 2004

(30) Foreign Application Priority Data
Aug. 27, 2003 (KR) 2003-59630

(51) Int. Cl. H04N 5/225

(52) U.S. Cl. 348/335

(57) ABSTRACT

A scanner motor assembly has a scanner motor for rotating a polygon mirror, a frame with a plurality of supporting members supporting the scanner motor, a plurality of anti-vibration members interposed between the scanner motor and the frame, and a plurality of fasteners that fix the scanner motor to the frame motor. With this construction, the scanner motor can be retained parallel to the frame because it is laid on the supporting members mounted on the frame, the anti-vibration members interposed between the scanner motor and the frame can reduce vibration, and thus noise generated due to the vibration can be suppressed.

### CROSS-REFERENCE TO RELATED APPLICATIONS

This application claims the benefit of Korean Patent Application No. 2003-59630, dated Aug. 27, 2003, in the Korean Intellectual Property Office, the disclosure of which is incorporated herein by reference.

### BACKGROUND OF THE INVENTION

1. Field of the Invention

The present invention relates to a scanner motor assembly employed in an electrophotographic image formation apparatus, and in particular, to a scanner motor with an improved anti-vibration arrangement.

2. Description of the Related Art

A scanner motor assembly is provided in a laser scanning unit of an electrophotographic image formation apparatus and serves to rotate a polygon mirror at a high speed, wherein the polygon mirror is adapted to deflect a laser beam generated from a light source unit toward a photosensitive medium.

FIG. 1 shows a conventional scanner motor assembly. As shown in FIG. 1, the conventional scanner motor assembly comprises a scanner motor 10 provided with a polygon mirror M, a frame 20 for supporting the scanner motor 10, and a plurality of fasteners 30 for connecting the scanner motor 10 to the frame 20. Here, the scanner motor 10 includes a printed circuit board 11, a stator 12 and a rotor 13. The printed circuit board 11 is mounted on the frame 20, the stator 12 is mounted on the printed circuit board 11, and the rotor 13 is connected to a rotary shaft 14 rotatably installed on the stator 12. The polygon mirror M is connected to the top of the rotor and then fixed by a clamp 15 so that it does not play. Each fastener 30 is inserted into a boss 21 of the frame 20 through a through-hole 11a formed in the printed circuit board 11, thereby fixing the scanner motor 10 to the frame 20.

However, in the conventional scanner motor assembly with the aforementioned construction, the scanner motor 10 is adjacent to the frame 20, and vibration generated when the scanner motor 10 rotates at a high speed is transferred directly to the frame 20. Because the frame 20 cannot absorb nor reduce such vibration, the vibration is then transferred to the polygon mirror M. Therefore, as shown in FIG. 2, the scanning intervals of a laser beam are unevenly distributed on a photosensitive medium P due to the vibration of the polygon mirror M during repeated scanning of the laser beam in the direction A. This phenomenon becomes a primary factor of deteriorating printing quality by causing gaps between the scanning lines imaged on the photosensitive medium P. In addition, vibration transferred to the frame 20 may introduce low-frequency noise into the system.

Sometimes it is possible to install an elastic damper between the scanner motor 10 and the frame 20 in order to prevent the vibration of the scanner motor 10 from being generated. However, because such a damper is apt to be deformed, the scanner motor 10 may be tilted to a side. If the polygon mirror M is tilted to either side even finely, the reflection direction of the polygon mirror M is changed and laser beam cannot be scanned to a correct position on the photosensitive medium P.

### SUMMARY OF THE INVENTION

The present invention has been conceived considering the above-mentioned problems occurring in the prior art, and an aspect of the present invention is to provide a scanner motor assembly that can reduce vibration generated while the scanner motor is driven, so that noise generated due to the vibration can be reduced and uniform electrostatic images can be formed on correct positions on a photosensitive medium.

In order to achieve the above aspect, according to present invention, there is provided a scanner motor assembly includes a scanner motor for rotating a polygon mirror, a frame provided with a plurality of supporting members for supporting the scanner motor, a plurality of anti-vibration members interposed between the scanner motor and the frame, and a plurality of fasteners for fixing the scanner motor to the frame motor.

With this construction, the scanner motor can be retained parallel to the frame because it is laid on the supporting members mounted on the frame, and the anti-vibration members interposed between the scanner motor and the frame can prevent vibration from being produced, whereby noise generated due to the vibration can be suppressed.

Additional aspects and/or advantages of the invention will be set forth in part in the description which follows and, in part, will be obvious from the description, or may be learned by practice of the invention.

According to an aspect of the present invention, the scanner motor compresses the anti-vibration members by way of the fasteners, whereby the scanner motor abuts against each of the top surfaces of the supporting members, wherein it is preferred that all the top surfaces of the supporting members have the same height.

In another aspect of the invention, the anti-vibration members may be formed of rubber or sponge, and various members capable of absorbing vibration, including coil springs, leaf springs and the like can be used for the anti-vibration members. The coil springs or the leaf springs can be formed of a metal or a plastic material. If the anti-vibration members consist of springs such as coil springs or leaf springs, it is preferable to interpose an plate between the scanner motor and each of the springs.

In an alternative aspect, the frame may be provided with a plurality of recessed parts, and one of the anti-vibration members is inserted into each recessed part.

In another aspect of the present invention, the frame is provided with a plurality of bosses, the scanner motor includes a base plate abutting against each of the top surfaces of the supporting members, and the fasteners penetrate through the base plate and the anti-vibration members and inserted into the bosses. The base plate may be either a PCB, on which various electronic devices are mounted, or a metallic or non-metallic plate connected to the scanner motor merely for fixing the scanner motor to the frame without any other function.

According to another aspect of the present invention, there is provided a method for assembling a scanner motor assembly. The method provides a frame provided with a plurality of supporting members; mounting a plurality of anti-vibration members on the frame to be higher than the supporting members; mounting a base plate of a scanner motor on the top surfaces of the anti-vibration members to abut against each of the top surfaces of the anti-vibration members; and connecting the scanner motor on the frame by using fasteners in such a way that the base plate abuts against the top surfaces of the supporting members, wherein the method may further comprises step of compressing the anti-vibration members prior to the step of connecting the scanner motor to the frame.

According to still another aspect of the present invention, there is also provided a method for assembling a scanner assembly. The method includes mounting a plurality of supporting members on a frame; mounting a plurality of anti-vibration members on the frame to be higher than the supporting members; mounting a base plate of a scanner motor on the top surfaces of the anti-vibration members to abut against each of the top surfaces of the anti-vibration members; connecting the scanner motor to the frame by using fasteners in such a way that the base plate abuts against the top surfaces of the supporting members; and removing the supporting members from the frame to form a gap between the scanner motor and the frame, wherein the method may further comprise step of compressing the anti-vibration members prior to the step of connecting the scanner motor and the frame.

According to these aspects, because the scan motor and a polygon mirror provided on the scanner motor can be mounted parallel to the frame by way of the supporting members and the scanner motor is supported by the anti-vibration members, anti-vibration effect can be enhanced.

In as aspect of the present invention, the supporting members are mounted on the frame so that all the top surfaces thereof have a same height.

### BRIEF DESCRIPTION OF THE DRAWINGS

The above and/or other aspects, features and advantages of the present invention will be more apparent and more readily appreciated from the following detailed description taken in conjunction with the accompanying drawings, in which:

FIG. 1 is a cross-sectional view illustrating a conventional scanner motor assembly;

FIG. 2 shows a photosensitive medium on which uneven scanning intervals of a laser beam appear due to vibration of a conventional scanner motor;

FIGS. 3A and 3B are views for explaining a scanner motor assembly according to a first embodiment of the present invention and a method for assembling the same partially in cross-section;

FIG. 4 is a top plan view of the scanner motor assembly according to the first embodiment shown in FIGS. 3A and 3B;

FIG. 5 is a view illustrating a scanner motor assembly according to a second embodiment of the present invention partially in cross-section;

FIG. 6 is a view illustrating a scanner motor assembly according to a third embodiment of the present invention partially in cross-section;

FIG. 7 is a view illustrating a scanner motor assembly according to a fourth embodiment of the present invention partially in cross-section; and

FIGS. 8A and 8B are views for explaining a scanner motor assembly according to a fifth embodiment of the present invention and a method for assembling the same partially in cross-section.

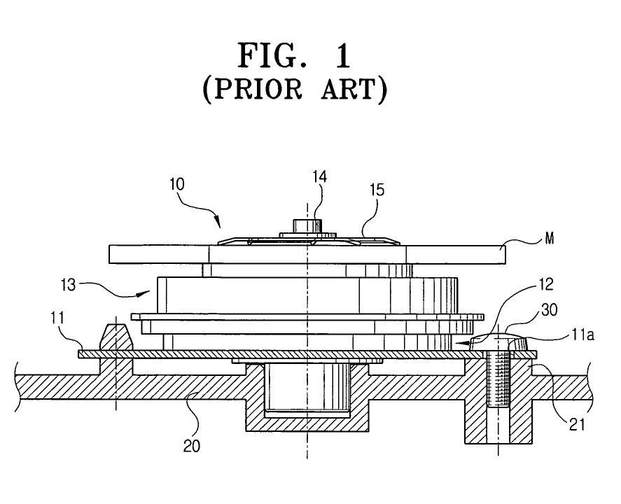

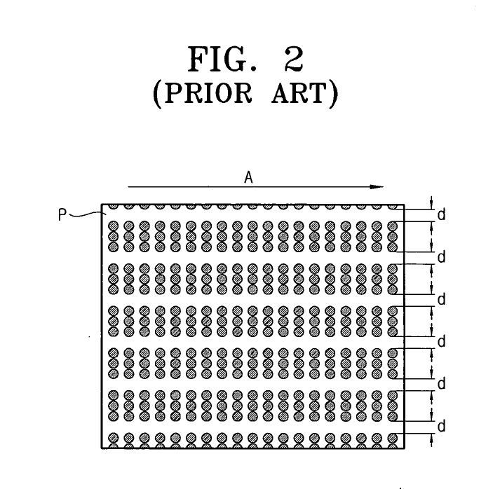

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

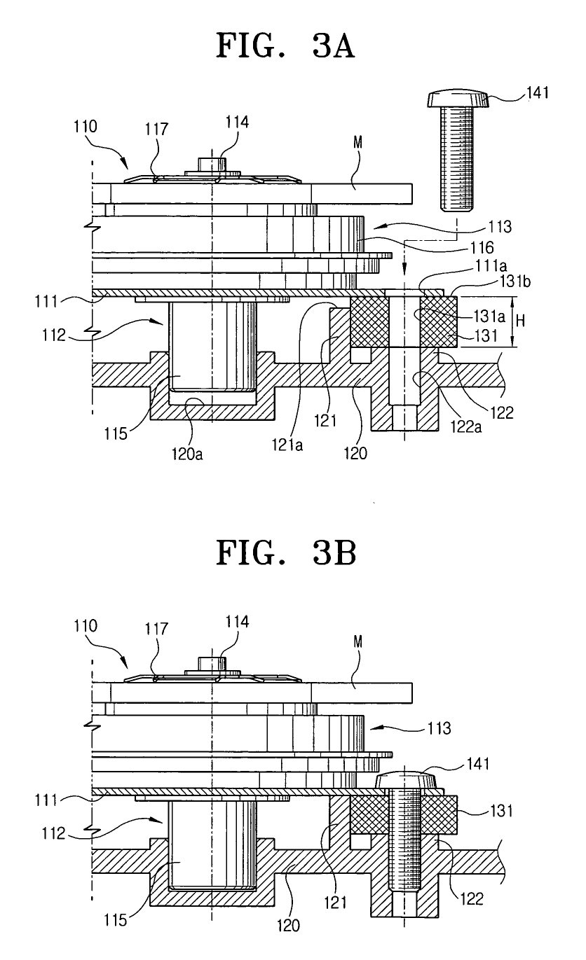

As shown in FIGS. 3A and 3B, the scanner motor assembly according to the first embodiment of the present invention comprises a scanner motor 110, a frame 120, a plurality of anti-vibration members 131, and a plurality of fasteners 141.

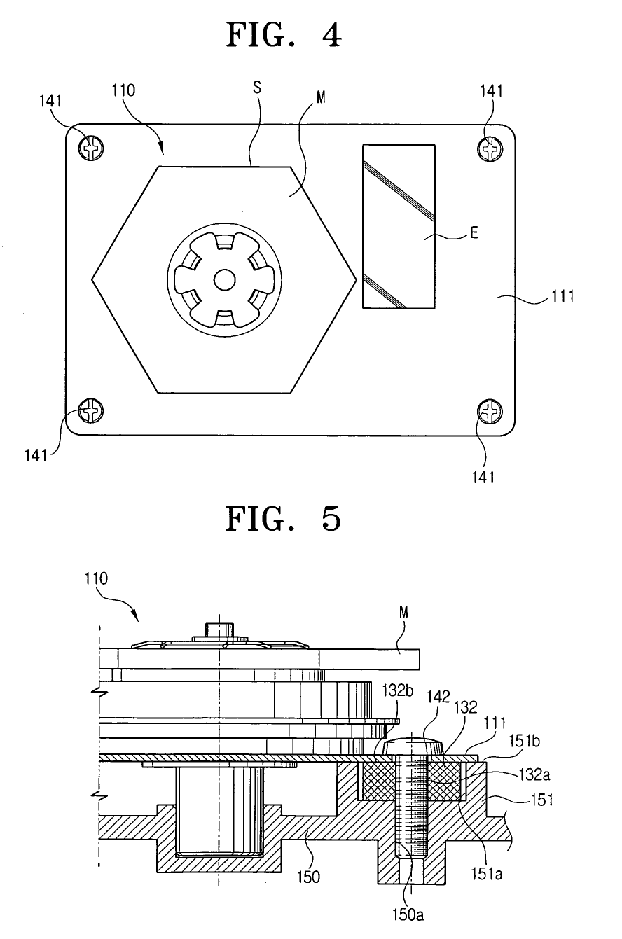

The scanner motor 110 serves to rotate a polygon mirror M provided with a plurality of reflecting surfaces S (see FIG. 4) at of a high speed, wherein the scanner motor 110 has a printed circuit board 111, a stator 112, a rotor 113, and a rotary shaft 114. The printed circuit board 111 is provided with various electronic devices E (see FIG. 4). The stator 112 is mounted on the printed circuit board 111 and includes a sleeve 115 and a coil (not shown). The sleeve 115 is secured in a recessed part 120a in the frame 120 and the coil is wound around a core (not shown) connected to the sleeve 115. The interior of the sleeve 115 is provided with a bearing (not shown). The rotor 113 includes a rotor case 116 fitted onto the rotary shaft 114, and a plurality of magnets (not shown) installed on the inner periphery of the rotor case 116. The polygon mirror M is fixed on the top of the rotor case 116 by a clamp 117. The rotor case 116 rotates at a high speed about the rotary shaft 114 by electromagnetic cooperation between the magnets (not shown) and the coil. The polygon mirror M also rotates at the high speed to deflect a laser beam scanned from a light source unit (not shown) to a photosensitive medium (not shown) side. Here, the printed circuit board 111 is provided with a plurality of through-holes 111a and abuts against the support member 121 to support the scanner motor 110. However, the present invention is not limited to this construction and it is possible to provide a separate metallic or non-metallic base plate to abut against the scanner motor, so that the base plate can support the scanner motor 110.

The frame 120 is installed within the body of an image formation apparatus and supports the scanner motor 110. The frame 120 is provided with a plurality of supporting members 121 and a plurality of bosses 122. The supporting members 121 support the printed circuit board 111, so that the scanner motor 110 is retained parallel to the frame 120. Each of the top ends of the supporting members 121 is provided with a top surface 121a, against which the scanner motor 110 abuts. The top surfaces 121a of the supporting members 121 are positioned at the same level in order to prevent the scanner motor 110 from being tilted. In one embodiment of the present invention, the frame 120 is provided with four supporting members 121, wherein the supporting members 121 may be formed to be integral with the frame 120 or formed separately from the frame 120 and then connected to the frame 120. A plurality of bosses 122 are provided adjacent the supporting members 121, respectively, for connecting the fasteners 141 to the frame 120. It is preferable to provide four bosses 122 to correspond to the supporting members 121, wherein each boss 122 is formed with an insertion hole 122a, into which the fastener 141 is inserted.

The anti-vibration members 131 are interposed between the printed circuit board 111 and the bosses 122 of the frame 120 for absorbing vibration generated when the rotor 113 and the polygon mirror M rotate. In this embodiment four anti-vibration members 131 are provided and the center of each anti-vibration member 131 is formed with a through-hole 131a, through which the fastening member 141 can be extended. The height H of the anti-vibration member 131 has such a size that the top surfaces 131b of the anti-vibration member 131 are positioned higher than the top surfaces 121a of the supporting members 121 when they are laid on the bosses 122. Because the anti-vibration members 131 have to absorb vibration generated in the scanner motor 110 so that the vibration is not transferred to the frame 120, they are formed of elastic rubber or sponge, which is not easily compressively deformed. It is understood that other suitable materials such as silicone and deformable plastics may be substituted for the elastic rubber or sponge to serve as dampeners or anti vibration members.

The fasteners 141 are used for connecting the scanner motor 110 to the frame 120. Any suitable fastener may be used for example screws, bolts or rivets.

Hereinafter, description is made of the method of assembling the scanner motor assembly according to the first embodiment of the present invention. In the assembling method to be described, because all four of the connection areas between the scanner motor 110 and the frame 120 are identical, only one connection area is described.

As shown in FIG. 3A, the anti-vibration member 131 is positioned on the top of the boss 122, so that the through-hole 131a of the anti-vibration member 131 is in line with the insertion hole 122a of the frame 120. At this time, the top surface 131b of the anti-vibration member 131 is located higher than the top surface 121a of the supporting member 121, thereby projecting from the latter. After positioning the anti-vibration member 131 on the frame 120, the sleeve 115 is inserted into the recessed part 120a of the frame 120, whereby the scanner motor 110 is installed on the frame 120. At this time, the through-hole 111a formed in the printed circuit board 111 is in line with the through-hole 131a of the anti-vibration member 131. And, the fastener 141 is inserted into the insertion hole 122a of the frame 120 through the through-holes 111a and 131a, thereby fixing the scanner motor 110 to the frame 120. This causes the printed circuit board 111 to compress the anti-vibration member 131 until it abuts against the top surface of the supporting member 121. If the fastening member 141 is tightened so that the top surface 121a of each supporting member 121 abuts against the printed circuit board 111 in this manner, the scanner motor 110 becomes parallel to the frame 120 and fixed to the frame 120.

In the above embodiment, although it is described that the fasteners 141 are inserted into the insertion holes 122a to install the scanner motor 110 on the frame 120, the present invention is not limited thereto. That is, it is also possible to provide screw bolts, or other fasteners, that extend through the through-holes 111a and 131a of the printed circuit board 111 and the anti-vibration member 131 and to fit nuts onto the screw bolts, respectively, thereby fixing the scanner motor 110.

Hereinbelow, scanner motor assemblies according to other embodiments of the present invention are described with reference to FIGS. 5 to 8B. In the following description of the scanner motor assembly according the other embodiments of the present invention, like reference numerals are used for like parts constructionally and functionally corresponding to those of the scanner motor assembly according to the first embodiment.

FIG. 5 shows a scanner motor assembly according to the second embodiment of the present invention. Referring to FIG. 5, the scanner motor assembly according to the second embodiment of the present invention comprises a scanner motor 110 provided with a polygon mirror M, a frame 150 for supporting the scanner motor 110, a plurality of anti-vibration members 132 for absorbing vibration generated by the scanner motor 110, and a plurality of fasteners 142. The constructions and functions of these components are similar to those of the scanner motor assembly according to the first embodiment but different from the first embodiment in that each of the supporting members 151, against which the scanner motor abuts, is formed in a circle. In this embodiment four supporting members 151 are used so that the scanner motor 110 is retained in a parallel state without being offset to a side. Each anti-vibration member 132 is installed within a recessed part 151a formed in each circular supporting member 151. Therefore, it is possible to easily install the anti-vibration members 132 so that a through-hole 132a of each anti-vibration member 132 is in line with an insertion hole 150a. If the anti-vibration members 132 are installed within the recessed parts 151a, the top surfaces 132b of the anti-vibration members 132 are initially positioned higher than the top surfaces 151b of the supporting members 151 as in the scanner motor assembly according to the first embodiment. The anti-vibration members 132 are formed of rubber or sponge and are pressed by the compressive force exerted by the fasteners 142 and the printed circuit board 111. If the connection of the scanner motor 110 to the frame 150 is completed, the printed circuit board 111 abuts against the top surfaces 151b of the support members 151. Because the assembling method of the scanner motor according to the second embodiment is the same as with the first embodiment, the description thereof is omitted.

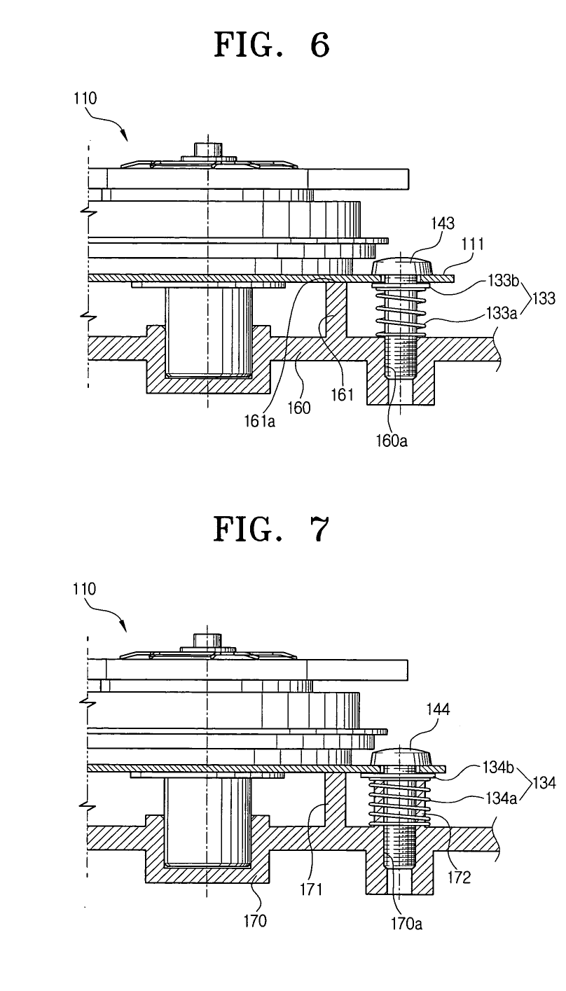

FIG. 6 shows a scanner motor assembly according to the third embodiment of the present invention. Referring to FIG. 6, the scanner motor assembly according to the third embodiment of the present invention comprises a scanner motor 110, a frame 160, a plurality of anti-vibration members 133, and a plurality of fasteners 143. Because the remaining components except the anti-vibration members 133 are the same as with the scanner motor assembly according to the first embodiment, the description thereof is omitted. In the scanner motor assembly according to the third embodiment, each anti-vibration member 133 consists of a coil spring 133a and a plate 133b. The plate 133b is formed of rubber or sponge that is capable of absorbing vibration. The anti-vibration member 133 is installed in the frame 160 to be in line with an insertion hole 160a formed in the frame 160, the plate 133b is initially positioned higher than the top surface 161a of the supporting member 161. If the fastening member 143 is inserted into the insertion hole 160a formed in the frame 160, the printed circuit board 111 compresses the plate 133b, whereby the coil spring 133a is compressed. If the coil spring 133a is pressed and the printed circuit board 111 abuts against the top surface of the supporting member 161, the assembly is completed.

FIG. 7 shows a scanner assembly according to the fourth embodiment of the present invention. Referring to FIG. 7, the scanner assembly according to the fourth embodiment comprises a scanner motor 110, a frame 170 having support members 171, a plurality of anti-vibration members 134, and a plurality of fasteners 144. The scanner motor assembly according to the fourth embodiment is the same as with that of the third embodiment except that the frame 170 is provided with bosses 172 each for supporting one anti-vibration member 134. Because each anti-vibration member 134, which consists of a coil spring 134a and a plate 134b, is fitted into the boss 172 formed in the frame 170, it is easy to position the anti-vibration member 134 to be in line with an insertion hole 170a formed in the frame 170. The remaining components and assembling method are the same as with those of the scanner motor assembly according to the first embodiment, and the description thereof is omitted.

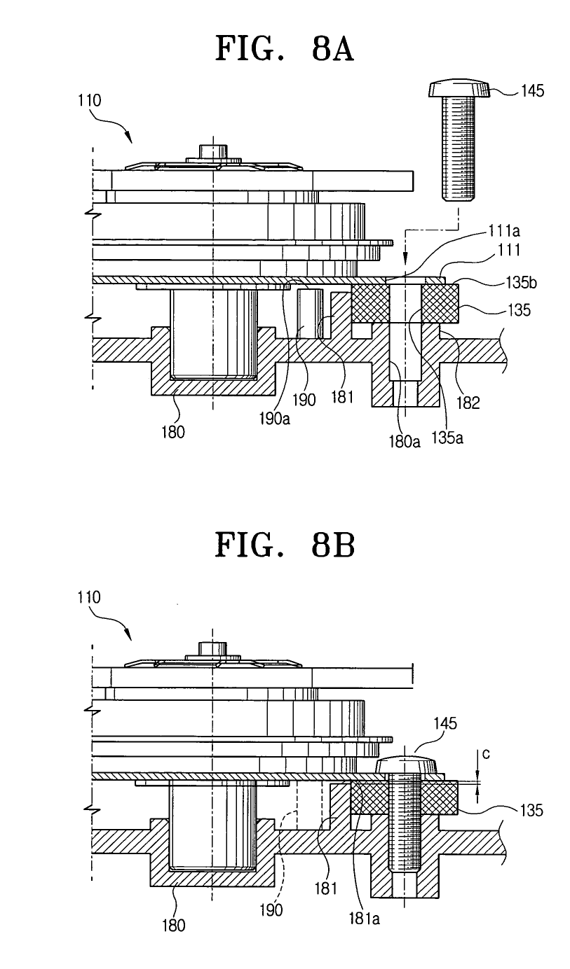

FIGS. 8A and 8B show a scanner motor assembly according to the fifth embodiment of the present invention. Referring to FIG. 8A, the scanner motor assembly according to the fifth embodiment comprises a scanner motor 110, a frame 180, a plurality of anti-vibration members 135, and a plurality of fasteners 145. The scanner motor assembly in this embodiment has a construction and function that are similar to the scanner motor assembly according to the first embodiment described above. The scanner motor assembly according to the fifth embodiment is different from the scanner motor assembly according to the first embodiment in that it further comprises a plurality of guide members 181 each for defining an installation position of one anti-vibration member 135 and each supporting member 190 is removably installed on the frame 180. It is preferable to provide four anti-vibration members 135 so that the scanner motor 110 can be retained in a parallel state without being tilted to a side. The guide members 181 may be omitted, and each supporting member 190 has a cylindrical shape provided with a flat and smooth top surface 190a at the top end thereof. Beyond the cylindrical shape, the supporting member 190 may be formed in various polygonal cross-sections and provided with a flat and smooth top surface at the top end thereof beyond the cylindrical shape. In addition, in the scanner motor assembly according to the fifth embodiment, the printed circuit board 111 of the scanner motor 110 is not supported by the supporting members 190 but supported by the anti-vibration members 135, as shown in FIG. 8B.

Hereinbelow, description is made for the assembling method of the scanner motor assembly according to the fifth embodiment of the present invention with reference to FIGS. 8A and 8B.

As shown in the drawings, each anti-vibration member 135 is positioned on one of the bosses 182 of the frame 180, so that the through-holes 135a of the anti-vibration members 135 are in line with the insertion holes 180a in the frame 180. Then, the supporting members 190 of cylindrical shape are installed to be adjacent to the anti-vibration members 135 on the frame 180, respectively. At this time, the top surfaces 135b of anti-vibration members 135 are positioned higher than the top surfaces 190a of the supporting members 190. After the anti-vibration members 135 and the supporting members 190 are installed, the printed circuit board 111 is positioned on the top surfaces 135a of the anti-vibration members 135 so that the through-holes 111a of the printed circuit boards 111 are in line with the through-holes 135a of the anti-vibration members 135, respectively. If the fasteners 145 are inserted into the insertion holes 180a in the state in which the through-holes 111a and 135a are respectively in line with the insertion hole 180a in this manner, the anti-vibration members 135 are compressed by the printed circuit board 111. If the anti-vibration members 135 are pressed and thus the printed circuit board 111 abuts against the top surfaces 190a of the supporting members 190, the scanner motor 110 becomes parallel to the frame 180. If the scanner motor 110 becomes parallel to the frame 180, all supporting members 190 are removed. Once the supporting members 190 are removed, the printed circuit board 111 of the scanner motor 110 is spaced apart from the top surfaces 181a of the guide members 181 by a predetermined gap c. Because the scanner motor 110 is supported by only the anti-vibration members 135, the anti-vibration effect can be further increased.

As described above, according to the present invention, a scanner motor 110 can be installed on a frame without being tilted to a side by supporting members, and vibration generated in the scanner motor can be absorbed by anti-vibration members interposed between the scanner motor and the frame. Accordingly, a polygon mirror M can be retained parallel to the frame without undesired vibrations being introduced into the system, and a laser beam deflected through the polygon mirror M can be uniformly imaged on correct positions on a photosensitive medium. Furthermore, noise generation due to the vibration of the scanner motor can be substantially reduced.

Although a few embodiments of the present invention have been shown and described, it would be appreciated by those skilled in the art that changes may be made in this embodiment without departing from the principles and spirit of the invention, the scope of which is defined in the claims and their equivalents.

1. A scanner motor assembly comprising:
a scanner motor rotating a polygon mirror;
a frame provided with a plurality of supporting members supporting the scanner motor;
a plurality of anti-vibration members interposed between the scanner motor and the frame; and
a plurality of fasteners fixing the scanner motor to the frame motor.

2. The scanner motor assembly according to claim 1, wherein the scanner motor compresses the anti-vibration members by way of the fasteners, whereby the scanner motor abuts against each of the top surfaces of the supporting members.

3. The scanner motor assembly according to claim 1, wherein the plurality of supporting members have an identical height.

4. The scanner motor assembly according to claim 1, wherein the anti-vibration members are formed of elastic material.

5. The scanner motor assembly according to claim 1, wherein the anti-vibration members are coil springs.

6. The scanner motor assembly according to claim 1, wherein the anti-vibration members are springs.

7. The scanner motor assembly according to claim 6, wherein a plate is interposed between the scanner motor and each spring.

8. The scanner motor assembly according to claim 1, wherein the frame is provided with a plurality of bosses, the scanner motor includes a base plate abutting against a top surface of the supporting members, and the fasteners penetrate through the base plate and the anti-vibration members and are inserted into the bosses.

9. The scanner motor assembly according to claim 1, wherein the frame is provided with a plurality of recessed parts, and each anti-vibration member is inserted into one of the recessed parts.

10. A method for assembling a scanner motor assembly, wherein the method comprises:
providing a frame with a plurality of supporting members;
mounting a plurality of anti-vibration members on the frame to be higher than the supporting members;
mounting a base plate of a scanner motor on the top surfaces of the anti-vibration members; and
connecting the scanner motor to the frame by using fasteners in such a way that the base plate abuts against the top surfaces of the supporting members.

11. The method according to claim 10, further comprising compressing the anti-vibration members prior to connecting the scanner motor to the frame.

12. The method according to claim 11, wherein the top surfaces of the compressed anti-vibration members and the top surfaces of the supporting members are at an equal height.

13. A method for assembling a scanner assembly, wherein the method comprises:
mounting a plurality of supporting members on a frame;
mounting a plurality of anti-vibration members on the frame to be higher than the supporting members;
mounting a base plate of a scanner motor on a top surface of each of the anti-vibration members to abut against each of the top surfaces of the anti-vibration members;
connecting the scanner motor to the frame by using fasteners in such a manner that the base plate abuts against a top surface of each of the supporting members; and
removing the supporting members from the frame to form a gap between the scanner motor and the frame.

14. The method according to claim 13, wherein the supporting members are mounted on the frame so that all the top surfaces of the supporting members have a same height.

15. The method according to claim 13, further comprising compressing the anti-vibration members prior to connecting the scanner motor to the frame.

16. An apparatus comprising:
a scanner motor disposed on a base plate; and
a frame having a plurality of dampeners, wherein the base plate is fastened to the frame by fasteners that engage the plurality of dampeners and the frame.

17. The apparatus of claim 16, wherein the base plate is a printed circuit board.

18. The apparatus of claim 16, wherein the base plate is fastened to the frame the dampeners are compressed so that the base plate rests on the frame and the dampeners.

19. The apparatus of claim 16, wherein the frame includes a plurality of support legs to orient the base plate parallel with the frame when the base plate is fastened to the frame.

20. The apparatus of claim 19, wherein the dampeners are rubber.

21. The apparatus of claim 19, wherein the dampeners are springs.
